(19) United States
(12) Patent Application Publication
(10) Pub. No.: US 2026/0046017 A1
(43) Pub. Date: Feb. 12, 2026

(54) RESOURCE ALLOCATION SCHEMES FOR NON-TERRESTRIAL COMMUNICATIONS

(71) Applicant: Apple Inc., Cupertino, CA (US)

(72) Inventors: Alexander Sayenko, Munich (DE); Anatoliy S. Ioffe, Sunnyvale, CA (US); Daniel Popp, Munich (DE)

(21) Appl. No.: 18/797,454

(22) Filed: Aug. 7, 2024

(51) Int. Cl. H04B 7/185; H04L 1/00

(52) U.S. Cl. CPC H04B 7/18513; H04L 1/0003

(57) ABSTRACT

Disclosed herein are methods, systems, and devices configured to perform operations including: transmitting capability information that indicates a number of resources blocks (RBs) that a user equipment (UE) supports for non-terrestrial network (NTN) communications in a satellite frequency band; receiving, in accordance with the capability information, scheduling information that allocates one or more RBs in the satellite frequency band for NTN communications between the UE and a network entity; and performing, in accordance with the scheduling information, the NTN communications using the one or more allocated RBs in the satellite frequency band. In some examples, the capability information indicates (i) a number of RBs supported by the UE for NTN communications in the satellite frequency band or (ii) a modulation and coding scheme (MCS) that can be used for the NTN communications in the satellite frequency band.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Fourth Generation Long Term Evolution (4G LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

Described herein are techniques for allocating resources in a satellite frequency band to a user equipment (UE) to facilitate non-terrestrial network (NTN) communications.

One aspect of the present disclosure relates to a method including: transmitting capability information that indicates a number of resources blocks (RBs) that a UE supports for NTN communications in a satellite frequency band; receiving, in accordance with the capability information, scheduling information that allocates one or more RBs in the satellite frequency band for NTN communications between the UE and a network entity; and performing, in accordance with the scheduling information, the NTN communications using the one or more allocated RBs in the satellite frequency band.

In some implementations, transmitting the capability information includes transmitting, via radio resource control (RRC) signaling, an information element (IE) indicating the number of RBs that the UE supports for NTN communications in the satellite frequency band.

In some implementations, the IE includes two or three bits that indicate a numerical value that corresponds to an index of an entry in a data structure, where the entry in the data structure specifies the number of RBs that the UE supports for NTN communications in the satellite frequency band.

In some implementations, transmitting the capability information that indicates the number of RBs includes one of: transmitting a capability information indicating a maximum number of RBs supported by the UE for NTN communications in the satellite frequency band, or transmitting a capability information indicating that any number of RBs in the satellite frequency band can be scheduled for NTN communications between the UE and the network entity.

In some implementations, the capability information further indicates one or more particular modulation and coding schemes (MCS) that the UE supports for NTN communications in the satellite frequency band.

In some implementations, the one or more particular MCS include a binary phase shift keying (BPSK) modulation scheme or a quadrature phase shift keying (QPSK) modulation scheme.

In some implementations, the method further includes: identifying a radio access technology (RAT) supported by the UE; and determining the number of RBs that the UE supports for NTN communications in the satellite frequency band according to the identified RAT

In some implementations, the RAT includes one of NTN narrowband internet of things (NB-IOT), NTN long term evolution (LTE) category M (CatM), or NTN fifth generation (5G) new radio (NR).

In some implementations, the indicated number of RBs is 1 RB, 2 RBs, 3 RBs, 4 RBs, 6 RBs, or 25 RBs.

In some implementations, a number of the one or more RBs allocated for the NTN communications is less than or equal to the number of RBs indicated by the capability information.

One aspect of the present disclosure relates to a method including: receiving capability information that indicates a number of RBs that a UE supports for NTN communications in a satellite frequency band; transmitting, in accordance with the capability information, scheduling information that allocates one or more RBs in the satellite frequency band for NTN communications between the UE and a network entity; and performing, in accordance with the scheduling information, the NTN communications using the one or more allocated RBs in the satellite frequency band.

In some implementations, receiving the capability information includes receiving, via RRC signaling, an IE indicating the number of RBs that the UE supports for NTN communications in the satellite frequency band.

In some implementations, the IE includes two or three bits that indicate a numerical value that corresponds to an index of an entry in a data structure, where the entry in the data structure specifies the number of RBs that the UE supports for NTN communications in the satellite frequency band.

In some implementations, receiving the capability information that indicates the number of RBs includes one of: receiving a capability information indicating a maximum number of RBs supported by the UE for NTN communications in the satellite frequency band, or receiving a capability information indicating that any number of RBs in the satellite frequency band can be scheduled for NTN communications between the UE and the network entity.

In some implementations, the method further includes: identifying a RAT supported by the UE; and determining the number of RBs the UE supports for NTN communications in the satellite frequency band according to the identified RAT.

In some implementations, the number of RBs scheduled for the NTN communications between the UE and the network entity is determined based at least on a bandwidth of the satellite frequency band.

One aspect of the present disclosure relates to a method including: determining that a wireless channel available for communications includes a satellite communications channel; in response to the determining, identifying one or more capabilities of a UE available for supporting communications over the satellite communications channel; and transmitting a capability information indicating the one or more capabilities of the UE that are available for supporting communications over the satellite communications channel.

In some implementations, identifying the one or more capabilities of the UE includes identifying one or more particular MCS that the UE supports for NTN communications in frequency bands of the satellite communications channel, the method further including: transmitting a capability information indicating the one or more particular MCS for supporting communications over the satellite communications channel.

In some implementations, identifying the one or more capabilities of the UE includes: identifying a RAT supported by the UE; and determining a number of RBs that the UE supports for communications over the satellite communications channel according to the identified RAT.

In some implementations, transmitting the capability information includes transmitting a capability information indicating the number of RBs that the UE supports for communications over the satellite communications channel.

In some implementations, transmitting the capability information includes transmitting, via RRC signaling, an IE indicating the number of RBs that the UE supports for NTN communications in the satellite communications channel.

In some implementations, the IE includes two or three bits that indicate a numerical value that corresponds to an index of an entry in a data structure, where the entry in the data structure specifies the number of RBs that the UE supports for NTN communications in the satellite communications channel.

In some implementations, transmitting the capability information that indicates the number of RBs includes one of: transmitting a capability information indicating a maximum number of RBs supported by the UE for NTN communications in the satellite communications channel, or transmitting a capability information indicating that any number of RBs in the satellite communications channel can be scheduled for NTN communications between the UE and a network entity.

One aspect of the present disclosure relates to a method including: determining that a wireless channel available for communications includes a satellite communications channel; receiving a capability information indicating one or more capabilities of a UE that are available for supporting communications over the satellite communications channel; and allocating one or more RBs in the satellite communications channel to the UE according to the one or more capabilities indicated by the capability information.

One aspect of the present disclosure relates to an apparatus including: one or more processors; and memory storing instructions that, when executed by the one or more processors, cause the apparatus to perform any of the foregoing operations.

One aspect of the present disclosure relates to a baseband processor configured to perform any of the foregoing operations.

One aspect of the present disclosure relates to a wireless device (such as a UE or a base station) comprising at least one processor configured to perform any of the foregoing operations.

One aspect of the present disclosure relates to a non-transitory computer-readable medium storing instructions that, when executed by one or more processors, cause the one or more processors to perform any of the foregoing operations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example resource diagram, according to some implementations.

FIG. 3 illustrates an example signaling diagram, according to some implementations.

FIG. 4 illustrates an example process flow, according to some implementations.

FIGS. 5 to 7 illustrate flowcharts of example methods, according to some implementations.

FIG. 8 illustrates an example UE, according to some implementations.

FIG. 9 illustrates an example access node, according to some implementations.

### DETAILED DESCRIPTION

Many radio access technologies (RATs), such as 5G NR, 4G/LTE category M (CatM), and 4G/LTE narrowband internet of things (NB-IOT), support non-terrestrial network (NTN) communications by mobile devices using satellite cells, e.g., when mobile devices are in a communications coverage area provided by satellites. NTN systems operate in satellite frequency bands, such as the L-band (around 1.6 GHz) or the S-band (around 2 GHz), which are designated for satellite communications. These frequency bands facilitate long-range communication between satellites and ground stations or mobile devices, which can be useful in remote, rural, and underserved areas where traditional network infrastructure is limited or non-existent.

Some NTN communications take place in satellite frequency bands that are adjacent to protected bands/services like global navigation satellite system (GNSS), global positioning system (GPS), radio astronomy, incumbent systems, etc. To limit interference with these protected bands/services, many satellite frequency bands have restrictions on emission-related parameters like maximum power reduction (MPR) or additional MPR (A-MPR). Organizations, network operators, and original equipment manufacturers (OEMs) that use satellite bands with emission regulations are responsible for ensuring that devices are compliant with all of these regulations. However, checking that all regulatory constraints are met can be a complex and resource-intensive process.

The framework described herein can significantly reduce the time and resources associated with regulatory testing by reducing the number of scenarios that are checked to ensure device compliance. For example, rather than testing all possible combinations of channel parameters (channel bandwidth, resource allocation size, channel location, modulation scheme, and maximum transmission power, among others), the regulatory testing process can be confined to a subset of parameters that are relevant to satellite communications. In some implementations, this involves excluding some high-order modulation schemes and resource block (RB) allocations that are not applicable to NTN communications.

To support the testing framework described herein, a UE may be configured to report which RB allocation size(s) the UE supports for a particular satellite band. This information can be signaled via radio resource control (RRC) signaling, such as the modifiedMPR-Behaviour information element (IE) described in 3GPP technical specification (TS) 38.101 and TS 38.331. In some implementations, the UE may report (i) a number of RBs that can be scheduled for a given satellite band, and/or (ii) a subset of modulation and coding schemes (MCSs) that can be used for the satellite band. In some cases, the reported number of RBs that can be scheduled for a given satellite band indicates the maximum number of RBs that can be scheduled for that satellite band. Accordingly, the network can schedule NTN communications (by allocating RBs to the UE) based on the capability information provided by the UE.

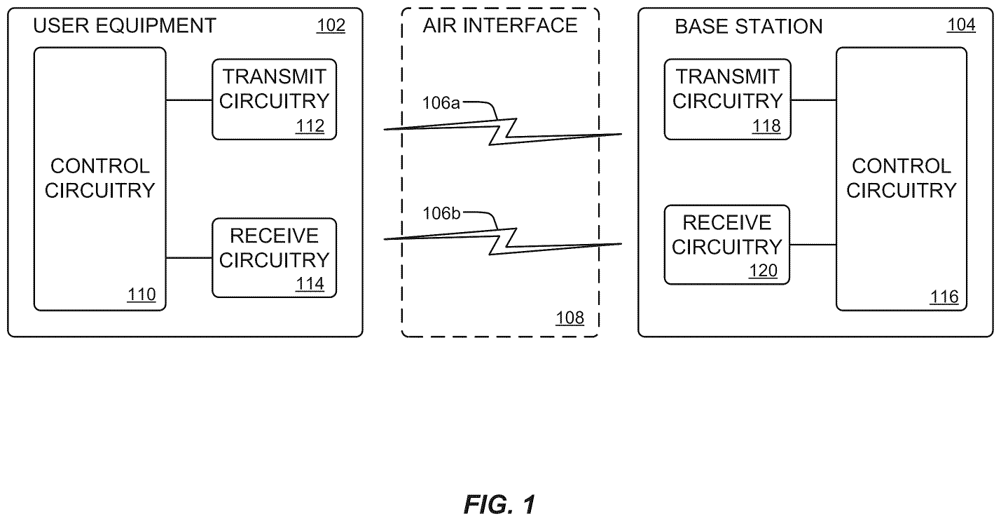

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can determine that a wireless channel available for communications includes a satellite communications channel and, in response to the determining, identify one or more capabilities of the UE 102 available for supporting communications over the satellite communications channel.

The transmit circuitry 112 can perform various operations described herein. For example, the transmit circuitry 112 can transmit a capability information indicating the one or more capabilities of the UE 102 that are available for supporting communications over the satellite communications channel. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described herein. For instance, the receive circuitry 114 can receive, in accordance with the capability information, scheduling information that allocates one or more RBs in a satellite frequency band for NTN communications between the UE 102 and the base station 104. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

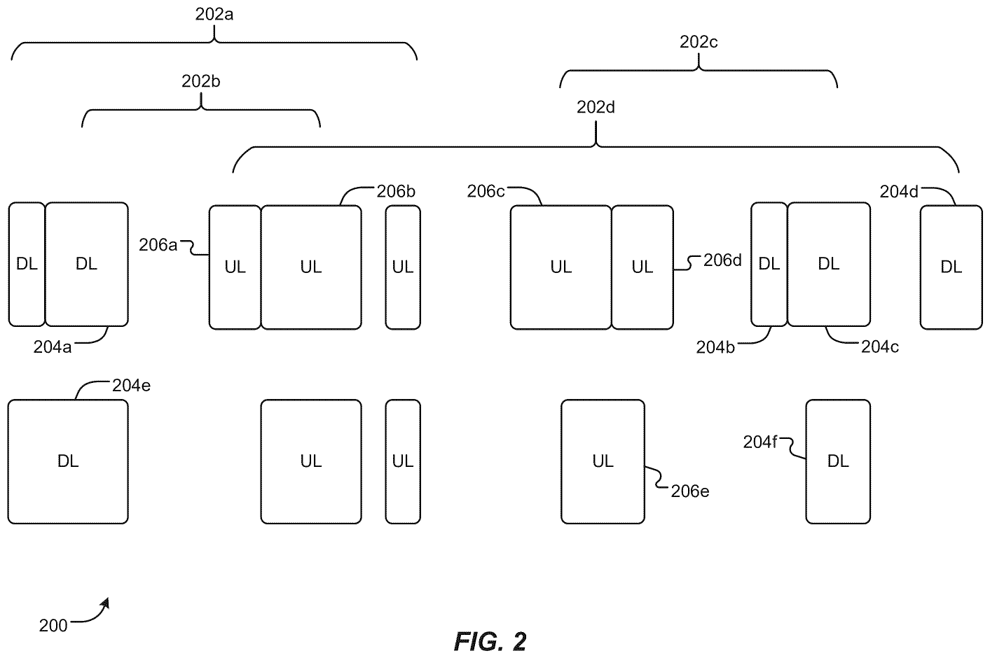

FIG. 2 illustrates an example resource diagram 200, according to some implementations. The resource diagram 200 includes a frequency band 202a (e.g., 3GPP band 253/n253), a frequency band 202b (e.g., 3GPP band 255/n255), a frequency band 202c (e.g., 3GPP band 256/n256), and a frequency band 202d (e.g., 3GPP band 254/n254). The frequency bands 202 depicted in FIG. 2 include various downlink channels 204 and uplink channels 206, which the UE 102 and/or the base station 104 may use for NTN communications.

In the example resource diagram 200 of FIG. 2, the downlink channel 204a occupies a bandwidth of 1525-1529 MHz, the downlink channel 204e occupies a bandwidth of 1518-1529 MHz, the uplink channel 206a occupies a bandwidth of 1610-1626.5 MHz, the uplink channel 206b occupies a bandwidth of 1626.5-1660 MHz, the uplink channel 206c occupies a bandwidth of 1980-2010 MHz, the uplink channel 206d occupies a bandwidth of 2010-2025 MHz, the uplink channel 206e occupies a bandwidth of 2000-2020 MHz, the downlink channel 204b occupies a bandwidth of 2160-2170 MHz, the downlink channel 204c occupies a bandwidth of 2170-2200 MHz, the downlink channel 204f occupies a bandwidth of 2180-2200 MHz, and the downlink channel 204d occupies a bandwidth of 2483.5-2500 MHz.

Some handheld/mobile devices (such as the UE 102) may support satellite communications. However, these satellite communications are typically limited to voice calls (data services are usually not offered). Lower satellite frequencies (around 1.5-2.5 GHz) are typically more suitable for hand-held devices, while higher satellite frequencies (around 10-20 GHz) are typically more suitable for customer premise equipment (CPE) devices.

Some of the frequency bands 202 depicted in FIG. 2 may include low-frequency satellite bands. For example, the frequency band 202b (3GPP band n255) includes an L-band around 1.6 Ghz, the frequency band 202c (3GPP band n256) includes an S-band around 2 GHz, and the frequency band 202d (3GPP band n254) includes an L-/S-band around 1.6/2.4 GHz. In comparison to terrestrial frequency bands, there are fewer low-frequency satellite bands, and the total bandwidth offered by existing satellite bands is usually smaller. Also, satellite frequency bands adjacent to other critical services (such as GNSS) may have relatively strict emission standards. For example, emissions from the frequency band 202d may be restricted to protect GPS, emissions from the frequency band 202c may be limited to protect NS_24 for Region 3, and emissions from the frequency band 202b may be limited to protect astronomy services.

Organizations (such as 3GPP) that use these frequency bands have to ensure that all regulatory constraints are met. However, checking whether these regulatory constraints are met can be a complex and resource-intensive process. For a particular satellite band, device emissions are checked for all combinations of the following parameters to ensure compliance: the configured channel bandwidth (e.g., 5 or 10 MHz), how many RBs are scheduled within the configured channel (e.g., a 5 MHz channel has 25 RBs, so 1-25 RBs can be scheduled at different positions within the channel), where the configured channel is placed within the band (e.g., at the lower/upper edge or the center of the channel), which MCS is used (e.g., PI/2 BPSK, QPSK, 16QAM, 64QAM), which maximum transmission power is assumed (e.g., 23 dB, 26 dBM 29 dBm), and so on.

Checking all regulatory constraints for all possible combinations of the foregoing parameters can be expensive and time-consuming. It takes time and resources to check each combination and ensure that all changes are reflected in wireless standards. For products, it takes time to test all possible combinations to ensure that a device (such as the UE 102) behaves in a compliant way. For satellite channels, however, most of these combinations are superfluous, and exhaustively testing each combination can be wasteful. As satellite communications become more prevalent and more frequency bands are added, it will be desirable to find ways to ensure device compliance without exhaustively testing all possible combinations. The techniques described herein can improve the efficiency of regulatory testing without diminishing the accuracy or reliability of the testing framework.

Using a 5 MHz channel (25 RBs) as an example for A-MPR simulations, 25−N simulations are run for every starting RB N. Those simulations are repeated for different modulation schemes. If the 5 MHz channel can reside in different parts of a frequency band, the simulations are repeated for different possible locations of the 5 MHz channel. Testing all possible channel parameters can be a challenging and time-consuming process. Moreover, checking all possible combinations may be unnecessary for some satellite radio frequency bands.

One aspect of the present disclosure relates to a framework for defining and checking/testing regulatory criteria for satellite frequency bands. Instead of defining/checking all possible combinations, a subset of possible combinations can be considered. This subset can be constrained based on the number of RB allocations and/or modulations supported. The framework described herein can be used for (i) devices that support only a subset of combinations and (ii) devices that support the full set of combinations. In general, satellite channels have a relatively stringent link budget, so the restricted set of combinations can be determined based on the number of RBs and modulations supported. There are different ways to enable signaling so that devices of different types can signal what RBs and MCSs they support and/or test for. The techniques described herein can significantly reduce the time and effort associated with device compliance and testing.

For restrictions based on MCS: the satellite channel uplink budget can be challenging, especially for the hand-held devices. In view of this, robust modulation schemes should be considered, and some high-order modulation schemes can be excluded. For example, “PI/2 BPSK” and “QPSK” may be considered as part of the restricted set

For restrictions based on the number of RBs: a high power spectral density (PSD) of the received signal may help achieve acceptable SINR at the satellite receiver. To attain a sufficiently high PSD, transmit power should be concentrated in a reduced set of uplink resources. Table 1 (shown below) summarizes a few options for different RATs:

TABLE 1
Restricted RB Sets for Different RATs

| | Maximum number of RBs that can be | | | | | | |
|---|---|---|---|---|---|---|---|
| | scheduled | | | | | | |
| Technology | 1 | 2 | 3 | 4 | 6 | 25 | Comments |
| NTN | X | | | | | | NB-IOT supports 1 RB, so 1 |
| NB-IOT | | | | | | | RB is the maximum |
| | | | | | | | allocation. |
| NTN LTE | (X) | (X) | (X) | (X) | X | | LTE CatM supports 6 RB as |
| CatM | | | | | | | the maximum allocation. |
| | | | | | | | Intermediate restricted |
| | | | | | | | values can be e.g. 1-4 RBs if |
| | | | | | | | there is a device built and |
| | | | | | | | tested for low data rates. |
| NTN | (X) | (X) | (X) | (X) | (X) | X | 5G/NR devices can use 6 RB |
| NR/5G | | | | | | | (which aligns with LTE |
| | | | | | | | CatM), but lower values can |
| | | | | | | | also be considered. 25 RB |
| | | | | | | | comes from the 5 MHz |
| | | | | | | | channel, which covers many |
| | | | | | | | cases. |

As shown in Table 1 above, signaling mechanisms can support the following possible allocations: 1 RB; 2-4 RBs; 6 RBs; 25 RBs; or no restriction (e.g., any number of RBs can be scheduled within the configured channel bandwidth). It may be sufficient to signal the highest number of RBs that can be scheduled for a particular RAT or frequency band. From a signaling perspective, this means a single value can be signaled. The value itself can indicate the actual number of RBs or an index that refers to the number of RBs. The indexing approach may be simpler, as it reduces the number of possible options and makes it easier for the network to implement. Tables 2 and 3 (shown below) illustrate two possible indexing schemes for a two-bit index (Table 2) and a 3-bit index (Table 3):

TABLE 2
RB Index Values (2-Bit Index)
2-bit index, 4 different index values

Applicability

| Index | Max RB | LTE CatM | 5G/NR |
|---|---|---|---|
| 0 | No restriction | X | X |
| 1 | 1 | X | X |
| 2 | 6 | | X |
| 3 | 25 | | X |

TABLE 3
RB Index Values (3-Bit Index)
3-bit index, 8 different values

Applicability

| Index | Max RB | LTE CatM | 5G/NR |
|---|---|---|---|
| 0 | No restriction | X | X |
| 1 | 1 | X | X |
| 2 | 2 | X | X |
| 3 | 3 | X | X |
| 4 | 4 | X | X |
| 5 | 6 | | X |
| 6 | 25 | | X |

To signal the information described above, two possible approaches are considered: leverage existing IEs (such as modifiedMPR-Behaviour) or introduce a new IE. For the first approach, the modifiedMPR-Behaviour IE is already a part of band signaling mechanisms for NR; accordingly, relatively few signaling changes would be involved. Also, since modifiedMPR-Behaviour was present in earlier releases of NR and NTN, the restricted set framework disclosed herein can be applied to earlier 3GPP releases. To support the signaling techniques described above, the definition of the modifiedMPR-Behaviour IE would be updated to clarify that, in the scope of satellite band(s), this element can convey additional information pertaining to a restricted RB/MCS set. A truncated field definition for the modifiedMPR-Behaviour IE is shown below in Table 4:

TABLE 4
Field Definition for modifiedMPR-Behaviour

| | | Definition | |
|---|---|---|---|
| | | (description of | |
| | | the supported | |
| NR | Index of Field | functionality if | |
| Band | (bit number) | indicator set to 1) | Notes |
| n30 | 0 (leftmost bit) | Regulations for | This bit is set to 1 by |
| | | network signaling | a UE supporting the |
| | | value NS_21 as | Rel-17 version of the |
| | | defined in Clause | [3GPP] specification. |
| | | 6.5.2.3.y of 38.101-1 | If the bit is not set, |
| | | v17.6.0 and A-MPR | then regulations for |
| | | as defined in Clause | NS_21 as defined in |
| | | 6.2.3.14 of 38.101-1 | Clause 6.5.2.3.3 of |
| | | v17.6.0 | 38.101-1 v16.11.0 |
| | | | and A-MPR as |
| | | | defined in Clause |
| | | | 6.2.3.14 of 38.101-1 |
| | | | v16.11.0 apply. |

The modifiedMPR-Behaviour IE is an 8-bit field that can be signaled for every band. Each band can have a band-specific interpretation of what a particular bit (or bit combination) means. In the except from the 3GPP specification shown in Table 4, band n30 defines bit 0 as additional “capability” for supporting additional band constraints. The modifiedMPR-Behaviour IE can be used to signal a restriction on the number of RBs supported/scheduled for NTN communications in a particular satellite frequency band. Depending on the approach, the corresponding bits can be defined to indicate the maximum number of supported RBs. As an example, two or three bits can signal an index value, which in turn can indicate the maximum number of RBs. This can serve as a general approach for all satellite bands. One example variant of the modifiedMPR-Behaviour IE is shown below in Table 5:

TABLE 5
Field Definition for modifiedMPR-Behaviour

| NR Band | Index of Field | Definition | Notes |
|---|---|---|---|
| n254 | 0-2 | 3 bits defining | The index value is |
| | (leftmost bits) | an index | mapped to a particular |
| | | value of 0-7 | number of RBs that |
| | | | can be scheduled by |
| | | | the UE. |

In other examples, a new IE can be added. This may offer a logically “cleaner” approach for the signaling. A corresponding IE can be added to earlier 3GPP releases to cover NTN bands in these releases.

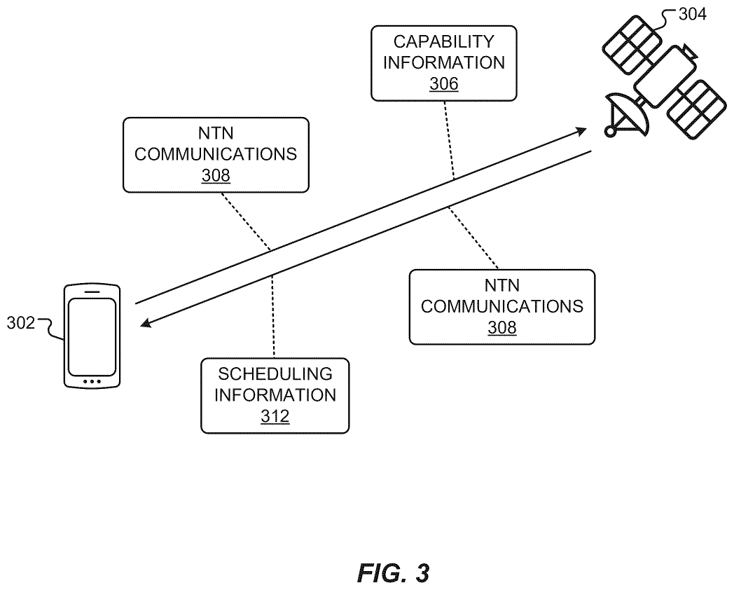

FIG. 3 illustrates an example signaling diagram 300, according to some implementations. The signaling diagram 300 may implement one or more aspects of the wireless network 100. For example, the signaling diagram 300 includes a UE 302, which may be an example of the UE 102 shown and described with reference to FIG. 1. Likewise, the signaling diagram 300 includes a satellite 304 (e.g., an access node of an NTN), which may be an example of aspects of the base station 104 shown and described with reference to FIG. 1.

Many RATs, such as 5G/NR, 4G/LTE CatM, and 4G/LTE NB-IOT, support NTN communications using satellite frequency bands, e.g., when coverage is provided by satellite cells within the coverage area or footprint of a satellite. 5G/NR-based NTN communications are based on the 5G/NR framework with additional NTN enhancements to support rich communication services. The maximum channel bandwidth for 5G/HR-based NTN communication is 30 MHz (up to 100 MHz in principle), which equates to 25 RBs for the 5 MHz at a 15 kHz subcarrier spacing (SCS). 4G/LTE CatM-based NTN communication is based on 4G/LTE CatM framework with NTN enhancements to support basic communication and data exchange. As described herein, LTE CatM (also referred to as LTE-M) is a cellular RAT that supports IOT and machine-to-machine (M2M) communications. The maximum channel bandwidth for 4G/LTE CatM-based NTN communication is 1.4 MHz, which equates to 6 RBs. 4G/LTE NB-IOT-based NTN communication is based on 4G/LTE and NB-IOT specific PHY layer protocols, which support basic IOT communications. The maximum channel bandwidth for 4G/LTE NB-IOT-based NTN communication is 200 kHz, which equates to 1 RB. Some network operators may deploy several RATs at once.

As described with reference to FIG. 2, some NTN communications may take place in satellite frequency bands that are adjacent to protected bands/services like GNSS, GPS, etc. To limit interference with these protected bands/services, many satellite frequency bands have restrictions on transmission parameters like MPR or A-MPR. Organizations, network operators, and OEMs that use satellite bands with emission regulations are responsible for ensuring that devices are compliant with all of these regulations. However, checking device emissions to ensure that all regulatory constraints are met can be a complex and resource-intensive process.

The framework described herein can reduce the time and resources associated with regulatory testing by reducing the number of combinations that are checked to ensure device compliance. For example, rather than testing all possible combinations of channel parameters (channel bandwidth, resource allocation size, channel location, modulation scheme, maximum transmission power, and so on), the regulatory testing process can be confined to a subset of parameters that are relevant to satellite communications. In some implementations, this involves excluding some high-order modulation schemes and RB allocations that are not applicable to NTN communications.

To support the testing framework described herein, the UE 302 may be configured to report capability information 306 that indicates which RB allocation size(s) the UE 302 supports for a particular satellite band. This capability information 306 can be signaled via RRC signaling, such as the modifiedMPR-Behaviour IE. In some implementations, the capability information 306 indicates (i) the maximum number of RBs that can be scheduled for a given satellite band and/or (ii) a subset of modulation schemes that can be used for the satellite band. Accordingly, the satellite 304 may transmit scheduling information 312 based on the capability information 306 provided by the UE 302. The scheduling information 312 may allocate one or more RBs for NTN communications 308 between the UE 302 and the satellite 304.

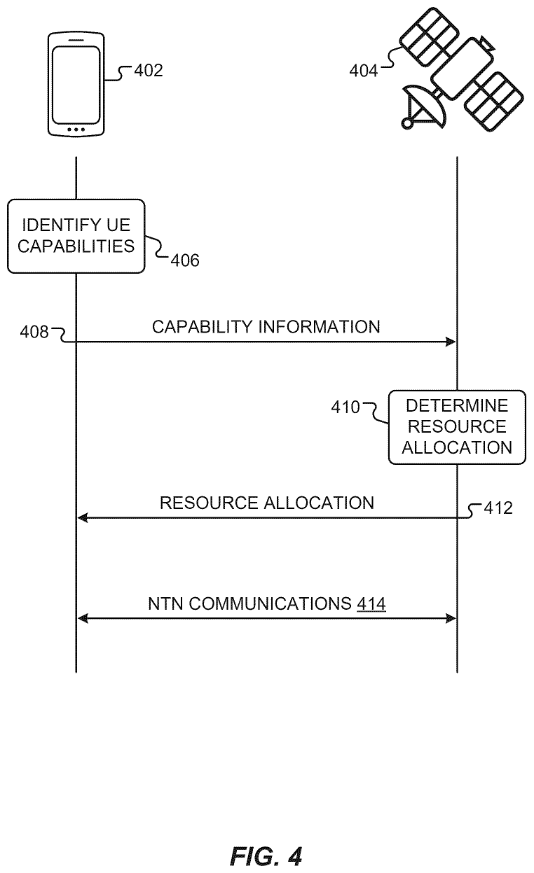

FIG. 4 illustrates an example process flow 400, according to some implementations. The process flow 400 may implement one or more aspects of the signaling diagram 300. For example, the process flow 400 includes a UE 402, which may be an example of the UE 302 shown and described with reference to FIG. 3. Likewise, the process flow 400 includes a satellite 404, which may be an example of the satellite 304 shown and described with reference to FIG. 3. The process flow 400 illustrates a resource allocation scheme for scheduling NTN communications based on UE capability information. In the following description of the process flow 400, operations between the UE 402 and the satellite 404 can be added, omitted, or performed in a different order (with respect to the exemplary order shown).

In the example process flow 400 of FIG. 4, the UE 402 determines that a wireless channel available for communications includes a satellite communications channel. In response to the determining, the UE 402 identifies (406) one or more capabilities of the UE 402 available for supporting communications over the satellite communications channel. In some implementations, identifying the one or more capabilities of the UE 402 includes identifying one or more supported MCSs or RB allocations based on a RAT supported by the UE 402, such as 5G/NR NTN, 4G/LTE CatM NTN, or 4G/LTE NB-IOT.

Accordingly, the UE 402 transmits (406) capability information that indicates a number of RBs the UE 402 can support for NTN communications over the satellite communications channel. The capability information can also indicate an MCS the UE supports for the NTN communications. In some examples, the capability information includes a field indicating a maximum number of RBs the UE 402 supports for the NTN communications. The field can include two or three bits. In some implementations, a value of the field corresponds to an index of an entry in a data structure (such as a table) that corresponds to the maximum number of RBs.

After receiving the capability information from the UE 402, the satellite 404 determines (408) a suitable RB allocation for the NTN communications. In some implementations, this involves allocating a number of RBs that is less than or equal to the number of RBs the UE 402 can support (as indicated by the capability information). For example, the satellite 404 may allocate 1 RB, 2 RBs, 3 RBs, 4 RBs, 6 RBs, or 25 RBs to the UE 402 for the NTN communications.

In turn, the satellite 404 transmits (410) scheduling information that indicates the RB allocation for the NTN communications. The scheduling information may also indicate an MCS to use for the NTN communications. In some implementations, the number of RBs scheduled for the NTN communications between the UE 402 and the satellite 404 is determined based on a bandwidth of the satellite communications channel.

Accordingly, the UE 402 performs (412) the NTN communications using the RB(s) allocated by the satellite 404. For example, the UE 402 may receive one or more downlink NTN communications from the satellite 404 and/or transmit one or more uplink NTN communications to the satellite 404 using one or more RBs associated with the satellite communications channel.

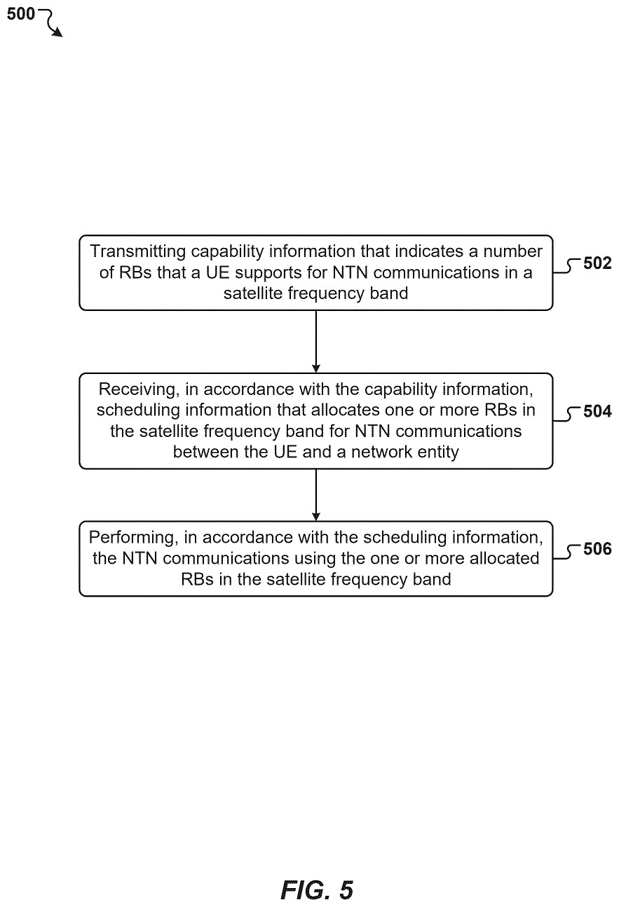

FIG. 5 illustrates a flowchart of an example method 500, according to some implementations. For clarity of presentation, the description that follows generally describes the method 500 in the context of other figures described herein. Although some aspects of the method 500 are described as being performed by the UE 102, it should be understood that operations of the method 500 can be performed, for example, by any suitable system, environment, software, hardware, or combination thereof. In some implementations, various steps of the method 500 can be run in parallel, in combination, in loops, or in any order. The example method 500 shown in FIG. 5 can be modified or reconfigured to include additional, fewer, or different steps (not shown in FIG. 5), which can be performed in the order shown or in a different order.

The method 500 includes transmitting (502) capability information that indicates a number of RBs that a UE supports for NTN communications in a satellite frequency band.

The method 500 further includes receiving (504), in accordance with the capability information, scheduling information that allocates one or more RBs in the satellite frequency band for NTN communications between the UE and a network entity.

Additionally, the method 500 includes performing (506), in accordance with the scheduling information, the NTN communications using the one or more allocated RBs in the satellite frequency band.

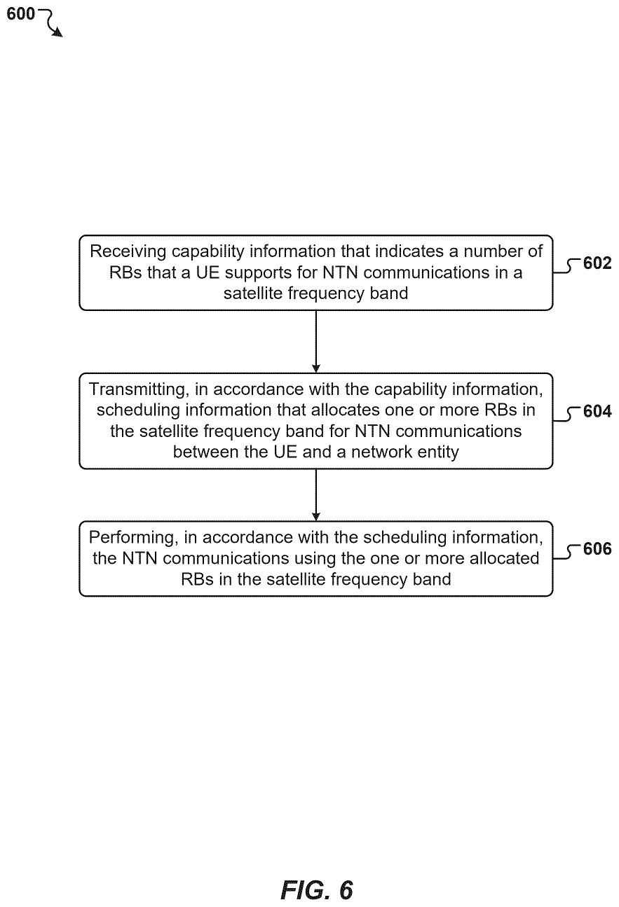

FIG. 6 illustrates a flowchart of an example method 600, according to some implementations. For clarity of presentation, the description that follows generally describes the method 600 in the context of other figures described herein. Although some aspects of the method 600 are described as being performed by the UE 102, it should be understood that operations of the method 600 can be performed, for example, by any suitable system, environment, software, hardware, or combination thereof. In some implementations, various steps of the method 600 can be run in parallel, in combination, in loops, or in any order. The example method 600 shown in FIG. 6 can be modified or reconfigured to include additional, fewer, or different steps (not shown in FIG. 6), which can be performed in the order shown or in a different order.

The method 600 includes receiving (602) capability information that indicates a number of RBs that a UE supports for NTN communications in a satellite frequency band

The method 600 further includes transmitting (604), in accordance with the capability information, scheduling information that allocates one or more RBs in the satellite frequency band for NTN communications between the UE and a network entity.

Additionally, the method 600 includes performing (606), in accordance with the scheduling information, the NTN communications using the one or more allocated RBs in the satellite frequency band.

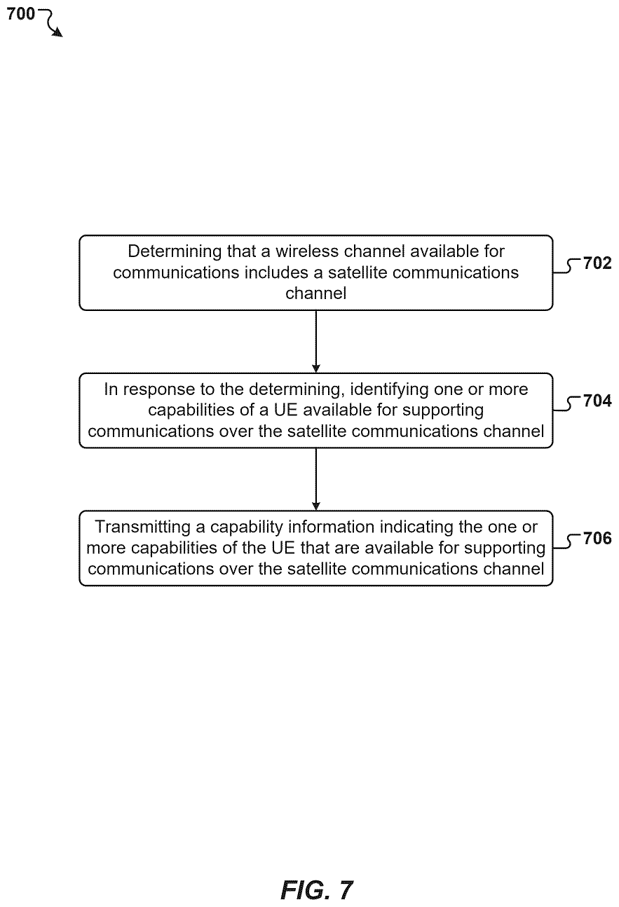

FIG. 7 illustrates a flowchart of an example method 700, according to some implementations. For clarity of presentation, the description that follows generally describes the method 700 in the context of other figures described herein. Although some aspects of the method 700 are described as being performed by the UE 102, it should be understood that operations of the method 700 can be performed, for example, by any suitable system, environment, software, hardware, or combination thereof. In some implementations, various steps of the method 700 can be run in parallel, in combination, in loops, or in any order. The example method 700 shown in FIG. 7 can be modified or reconfigured to include additional, fewer, or different steps (not shown in FIG. 7), which can be performed in the order shown or in a different order.

The method 700 includes determining (702) that a wireless channel available for communications includes a satellite communications channel

The method 700 further includes: in response to the determining, identifying (704) one or more capabilities of a UE available for supporting communications over the satellite communications channel.

Additionally, the method 700 includes transmitting (706) a capability information indicating the one or more capabilities of the UE that are available for supporting communications over the satellite communications channel.

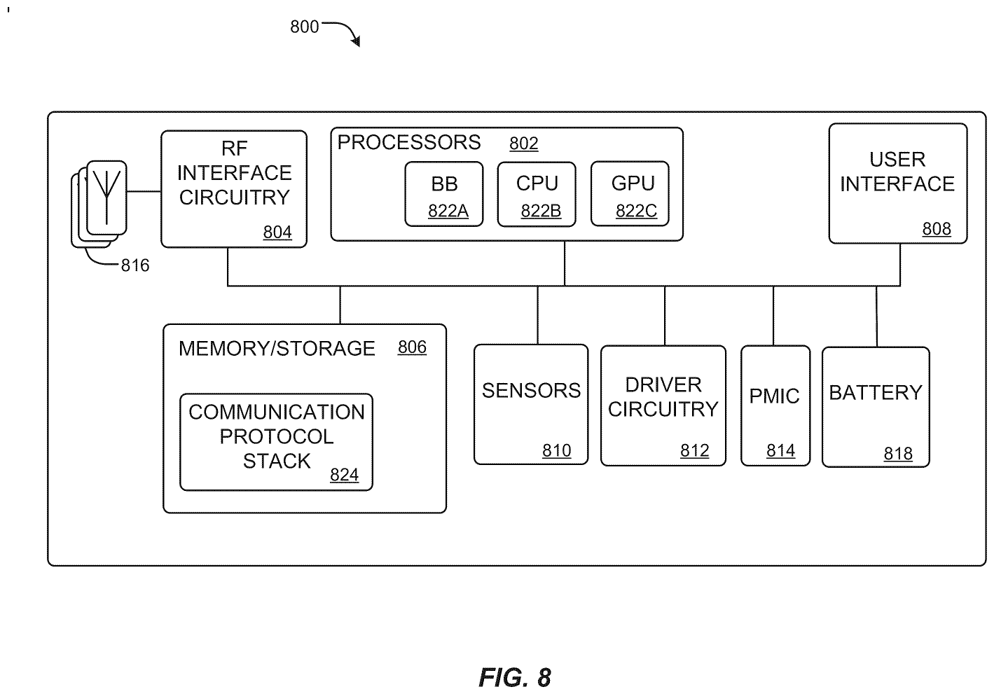

FIG. 8 illustrates an example UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, one or more antenna(s) 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc., that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 816. In various implementations, the RF interface circuitry 804 may be configured to transmit/receive signals in a manner compatible with NR access technologies.

The antenna(s) 816 may include one or more antenna elements to convert electrical signals into radio waves to travel through the air and to convert received radio waves into electrical signals. The antenna elements may be arranged into one or more antenna panels. The antenna(s) 816 may have antenna panels that are omnidirectional, directional, or a combination thereof to enable beamforming and multiple input, multiple output communications. The antenna(s) 816 may include microstrip antennas, printed antennas fabricated on the surface of one or more printed circuit boards, patch antennas, phased array antennas, etc. The antenna(s) 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

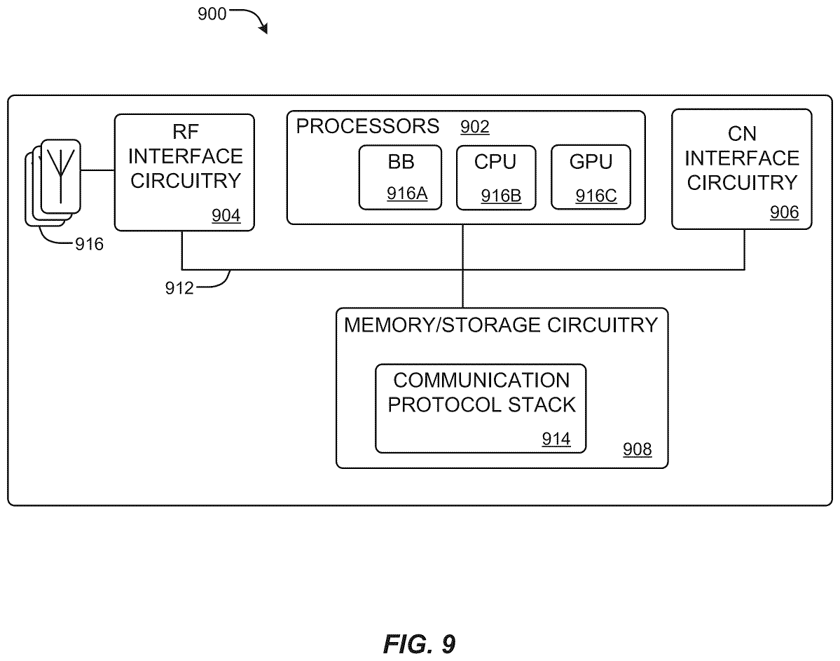

FIG. 9 illustrates an example access node 900 (e.g., a base station or gNB), according to some implementations. The access node 900 may be similar to and substantially interchangeable with base station 104. The access node 900 may include processors 902, RF interface circuitry 904, core network (CN) interface circuitry 906, memory/storage circuitry 908, and one or more antenna(s) 910.

The components of the access node 900 may be coupled with various other components over one or more interconnects 912. The processors 902, RF interface circuitry 904, memory/storage circuitry 908 (including communication protocol stack 914), antenna(s) 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental regulations for maintaining the privacy of users. In particular, personally identifiable information data should be managed and handled to minimize risks of unintentional or unauthorized access or use, and the nature of authorized use should be clearly indicated to users.

We claim:

1. An apparatus comprising:
one or more processors; and
memory storing instructions that, when executed by the one or more processors, cause the apparatus to perform operations comprising:
transmitting capability information that indicates a number of resources blocks (RBs) that a user equipment (UE) supports for non-terrestrial network (NTN) communications in a satellite frequency band;
receiving, in accordance with the capability information, scheduling information that allocates one or more RBs in the satellite frequency band for NTN communications between the UE and a network entity; and
performing, in accordance with the scheduling information, the NTN communications using the one or more allocated RBs in the satellite frequency band.

2. The apparatus of claim 1, wherein transmitting the capability information comprises transmitting, via radio resource control (RRC) signaling, an information element (IE) indicating the number of RBs that the UE supports for NTN communications in the satellite frequency band.

3. The apparatus of claim 2, wherein the IE indicates a numerical value that corresponds to an index of an entry in a data structure, and
wherein the entry in the data structure specifies the number of RBs that the UE supports for NTN communications in the satellite frequency band.

4. The apparatus of claim 1, wherein transmitting the capability information that indicates the number of RBs comprises one of:
transmitting a capability information indicating a maximum number of RBs supported by the UE for NTN communications in the satellite frequency band, or
transmitting a capability information indicating that any number of RBs in the satellite frequency band can be scheduled for NTN communications between the UE and the network entity.

5. The apparatus of claim 1, wherein the capability information further indicates one or more particular modulation and coding schemes (MCS) that the UE supports for NTN communications in the satellite frequency band.

6. The apparatus of claim 5, wherein the one or more particular MCS comprise a binary phase shift keying (BPSK) modulation scheme or a quadrature phase shift keying (QPSK) modulation scheme.

7. The apparatus of claim 1, the operations further comprising:
identifying a radio access technology (RAT) supported by the UE; and
determining the number of RBs that the UE supports for NTN communications in the satellite frequency band according to the identified RAT.

8. The apparatus of claim 7, wherein the RAT comprises one of NTN narrowband internet of things (NB-IOT), NTN long term evolution (LTE) category M (CatM), or NTN fifth generation (5G) new radio (NR).

9. The apparatus of claim 1, wherein the indicated number of RBs is 1 RB, 2 RBs, 3 RBs, 4 RBs, 6 RBs, or 25 RBs.

10. The apparatus of claim 1, wherein a number of the one or more RBs allocated for the NTN communications is less than or equal to the number of RBs indicated by the capability information.

11. An apparatus comprising:
one or more processors; and
memory storing instructions that, when executed by the one or more processors, cause the apparatus to perform operations comprising:
receiving capability information that indicates a number of resources blocks (RBs) that a user equipment (UE) supports for non-terrestrial network (NTN) communications in a satellite frequency band;
transmitting, in accordance with the capability information, scheduling information that allocates one or more RBs in the satellite frequency band for NTN communications between the UE and a network entity; and
performing, in accordance with the scheduling information, the NTN communications using the one or more allocated RBs in the satellite frequency band.

12. The apparatus of claim 11, wherein receiving the capability information comprises receiving, via radio resource control (RRC) signaling, an information element (IE) indicating the number of RBs that the UE supports for NTN communications in the satellite frequency band.

13. The apparatus of claim 12, wherein the IE indicates a numerical value that corresponds to an index of an entry in a data structure, and
wherein the entry in the data structure specifies the number of RBs that the UE supports for NTN communications in the satellite frequency band.

14. The apparatus of claim 13, wherein receiving the capability information that indicates the number of RBs comprises one of:
receiving a capability information indicating a maximum number of RBs supported by the UE for NTN communications in the satellite frequency band, or
receiving a capability information indicating that any number of RBs in the satellite frequency band can be scheduled for NTN communications between the UE and the network entity.

15. The apparatus of claim 10, wherein the capability information further indicates one or more particular modulation and coding schemes (MCS) that the UE supports for NTN communications in the satellite frequency band.

16. The apparatus of claim 10, wherein the number of RBs scheduled for the NTN communications between the UE and the network entity is determined based at least on a bandwidth of the satellite frequency band.

17. An apparatus comprising:
one or more processors; and
memory storing instructions that, when executed by the one or more processors, cause the apparatus to perform operations comprising:
determining that a wireless channel available for communications comprises a satellite communications channel;
in response to the determining, identifying one or more capabilities of a user equipment (UE) available for supporting communications over the satellite communications channel; and
transmitting a capability information indicating the one or more capabilities of the UE that are available for supporting communications over the satellite communications channel.

18. The apparatus of claim 17, wherein identifying the one or more capabilities of the UE comprises identifying one or more particular modulation and coding schemes (MCS) that the UE supports for NTN communications in frequency bands of the satellite communications channel, the operations further comprising:
transmitting a capability information indicating the one or more particular MCS for supporting communications over the satellite communications channel.

19. The apparatus of claim 17, wherein identifying the one or more capabilities of the UE comprises:
identifying a radio access technology (RAT) supported by the UE; and
determining a number of resources blocks (RBs) that the UE supports for communications over the satellite communications channel according to the identified RAT.

20. The apparatus of claim 17, wherein transmitting the capability information comprises:
transmitting a capability information indicating the number of RBs that the UE supports for communications over the satellite communications channel.
